(19) United States
(12) Patent Application Publication
(10) Pub. No.: US 2014/0322547 A1
(43) Pub. Date: Oct. 30, 2014

(54) Antimicrobial Glass Articles and Methods for Making and Using Same

(71) Applicant: CORNING INCORPORATED, CORNING, NY (US)

(72) Inventors: Odessa Natalie Petzold, Elmira, NY (US); Wageesha Senaratne, Horseheads, NY (US); Ying Wei, Painted Post, NY (US)

(73) Assignee: CORNING INCORPORATED, CORNING, NY (US)

(21) Appl. No.: 14/259,683

(22) Filed: Apr. 23, 2014

Related U.S. Application Data
(60) Provisional application No. 61/817,800, filed on Apr. 30, 2013.

(51) Int. Cl. A01N 55/00

(52) U.S. Cl. CPC A01N 55/00
USPC 428/429; 427/407.2

(57) ABSTRACT

Described herein are coated glass or glass-ceramic articles having improved antimicrobial efficacy. Further described are methods of making and using the improved articles. The coated articles generally include a glass or glass-ceramic substrate and an antimicrobial coating disposed thereon. The antimicrobial coating is not a free-standing adhesive film, but a coating that is formed on or over at least a portion of a surface of the glass or glass-ceramic substrate.

### CROSS-REFERENCE TO RELATED APPLICATIONS

This application claims the benefit of priority under 35 U.S.C. §119 of U.S. Provisional Application Ser. No. 61/817,800 filed on Apr. 30, 2013, the content of which is relied upon and incorporated herein by reference in its entirety.

### TECHNICAL FIELD

The present disclosure relates generally to antimicrobial coatings. More particularly, the various embodiments described herein relate to glass or glass-ceramic articles having antimicrobial coatings disposed thereon such that the coated articles exhibit improved antimicrobial efficacy, as well as to methods of making and using the coated articles.

### BACKGROUND

Touch-activated or -interactive devices, such as screen surfaces (e.g., surfaces of electronic devices having user-interactive capabilities that are activated by touching specific portions of the surfaces), have become increasingly more prevalent. In general, these surfaces should exhibit high optical transmission, low haze, and high durability, among other features. As the extent to which the touch screen-based interactions between a user and a device increases, so too does the likelihood of the surface harboring microorganisms (e.g., bacteria, fungi, viruses, and the like) that can be transferred from user to user.

To minimize the presence of microbes on glass, so-called “antimicrobial” properties have been imparted to a variety of glass articles. Such antimicrobial glass articles, regardless of whether they are used as screen surfaces of touch-activated devices or in other applications, can exhibit poor antimicrobial efficacy under ordinary use conditions despite performing adequately under generally-accepted or standardized testing conditions, can exhibit poor optical or aesthetic properties when exposed to certain conditions during fabrication and/or ordinary use, and/or can be costly to manufacture (e.g., when expensive metals or alloys are used as the antimicrobial agent or when additional steps are required to introduce the antimicrobial agent into or onto the glass). These deficiencies ultimately can make it impractical to implement the antimicrobial glass articles.

There accordingly remains a need for technologies that provide glass articles with improved antimicrobial efficacy under both ordinary use and generally-accepted testing conditions. It would be particularly advantageous if such technologies did not adversely affect other desirable properties of the articles, such as optical or aesthetic properties. It would also be advantageous if such technologies could be produced in a relatively low-cost manner. It is to the provision of such technologies that the present disclosure is directed.

### BRIEF SUMMARY

Described herein are various articles that have improved antimicrobial efficacy, along with methods for their manufacture and use.

One type of coated article includes a glass or glass-ceramic substrate and an antimicrobial coating disposed on at least a portion of a surface of the glass or glass-ceramic substrate, such that the antimicrobial coating includes an at least partially cured siloxane having organic side chains, wherein at least a portion of the organic side chains include protonated amine substituents or amine substituents having at least one hydrogen.

This type of coated article can further include a functional layer interposed between the glass or glass-ceramic substrate and the antimicrobial coating, disposed on at least a portion of the antimicrobial coating, and/or disposed on the surface of the glass or glass-ceramic substrate in a region on which the antimicrobial coating is not disposed. The functional layer can include a fingerprint-resistant coating, smudge-resistant coating, reflection-resistant coating, a glare-resistant coating, a color-providing composition, an environmental barrier coating, or an electrically conductive coating.

With respect to the substrate of this type of coated article, in some cases, it can be formed from a silicate glass, borosilicate glass, aluminosilicate glass, boroaluminosilicate glass, or similar glass, which optionally includes an alkali or alkaline earth modifier. In other cases, the substrate can be formed from a glass-ceramic comprising a glassy phase and a ceramic phase, where the ceramic phase includes β-spodumene, β-quartz, nepheline, kalsilite, carnegieite, or a similar ceramic material. In some applications, the glass or glass-ceramic substrate can have an average thickness of less than or equal to about 2 millimeters.

With respect to the antimicrobial coating of this type of coated article, in some cases, it can be formed from a uncured or partially-cured siloxane coating precursor material comprising organic side chains wherein at least a portion of the organic side chains comprise protonated amine substituents or amine substituents comprising at least one hydrogen. For example, such materials include partially-cured primary amine-substituted linear alkyl silsesquioxanes, one example of which is a partially-cured aminopropyl silsesquioxane.

In some cases, the coated article can exhibit at least a 5 log reduction in a concentration of at least Staphylococcus aureus, Enterobacter aerogenes, and Pseudomomas aeruginosa bacteria under JIS Z 2801 (2000) testing conditions. Similarly, in some cases, the coated article can exhibit at least a 2 log reduction in a concentration of at least Staphylococcus aureus, Enterobacter aerogenes, and Pseudomomas aeruginosa bacteria under modified United States Environmental Protection Agency “Test Method for Efficacy of Copper Alloy Surfaces as a Sanitizer” testing conditions, wherein the modified conditions include substitution of a copper-containing surface for the coated article and substitution of the glass or glass-ceramic substrate without the antimicrobial coating disposed thereon as a control sample.

In certain implementations, the glass or glass-ceramic substrate is a chemically strengthened glass or glass-ceramic substrate having a layer under compression that extends from the surface of the glass or glass-ceramic substrate inward to a selected depth. For example, a compressive stress of the layer under compression can be about 400 megaPascals to about 1200 megaPascals, and the depth of the layer under compression can be about 30 micrometers to about 80 micrometers.

Applications for, or uses of, this type of coated article include forming a portion of a touch-sensitive display screen or cover plate for an electronic device, a non-touch-sensitive component of an electronic device, a surface of a household appliance, a surface of medical equipment, a biological or medical packaging vessel, an architectural component, a surface of a vehicle component, or the like.

One type of method for making a coated article can include forming an antimicrobial coating form an antimicrobial coating precursor material on at least a portion of a surface of a glass or glass-ceramic substrate. The antimicrobial coating can be an at least partially cured siloxane having organic side chains, wherein at least a portion of the organic side chains include protonated amine substituents or amine substituents having at least one hydrogen. The antimicrobial coating precursor material can be an uncured or partially-cured siloxane coating precursor material having organic side chains wherein at least a portion of the organic side chains include protonated amine substituents or amine substituents having at least one hydrogen.

In certain cases, the method can further include a step of forming a functional layer on at least a portion of the surface of the glass or glass-ceramic substrate prior to forming the antimicrobial coating, wherein the functional layer includes a fingerprint-resistant coating, smudge-resistant coating, reflection-resistant coating, a glare-resistant coating, a color-providing composition, an environmental barrier coating, or an electrically conductive coating.

In other cases, the method can further include a step of forming a functional layer on at least a portion of the antimicrobial coating, wherein the functional layer includes a fingerprint-resistant coating, smudge-resistant coating, reflection-resistant coating, a glare-resistant coating, a color-providing composition, an environmental barrier coating, or an electrically conductive coating.

In other cases, the method can further include a step of forming a functional layer on a region on the surface of the glass or glass-ceramic substrate on which the antimicrobial coating is not disposed, wherein the functional layer includes a fingerprint-resistant coating, smudge-resistant coating, reflection-resistant coating, a glare-resistant coating, a color-providing composition, an environmental barrier coating, or an electrically conductive coating.

It is to be understood that both the foregoing brief summary and the following detailed description describe various embodiments and are intended to provide an overview or framework for understanding the nature and character of the claimed subject matter.

### DETAILED DESCRIPTION

Exemplary embodiments will now be described in detail. Throughout this description, various components may be identified having specific values or parameters. These items, however, are provided as being exemplary of the present disclosure. Indeed, the exemplary embodiments do not limit the various aspects and concepts, as many comparable parameters, sizes, ranges, and/or values may be implemented. Similarly, the terms “first,” “second,” “primary,” “secondary,” “top,” “bottom,” “distal,” “proximal,” and the like, do not denote any order, quantity, or importance, but rather are used to distinguish one element from another. Further, the terms “a,” “an,” and “the” do not denote a limitation of quantity, but rather denote the presence of “at least one” of the referenced item.

Described herein are various antimicrobial glass articles that have improved antimicrobial efficacy both under ordinary use conditions and under generally-accepted testing conditions, along with methods for their manufacture and use. The term “antimicrobial” refers herein to the ability to kill or inhibit the growth of more than one species of more than one type of microbe (e.g., bacteria, viruses, fungi, and the like). In general, the improved articles and methods described herein involve the use of an antimicrobial coating disposed directly or indirectly on at least a portion of a surface of a glass or glass-ceramic substrate.

The antimicrobial coatings beneficially provide the articles with improved antimicrobial efficacy both under ordinary use conditions and under generally-accepted testing conditions relative to similar or identical articles that lack the antimicrobial coating. In addition, and as will be described in more detail below, the coated articles can exhibit high transmission, low haze, and high durability, among other features.

As stated above, the substrate on which the antimicrobial coating is directly or indirectly disposed can comprise a glass or glass-ceramic material. The choice of glass or glass-ceramic material is not limited to a particular composition, as improved antimicrobial efficacy can be obtained using a variety of glass or glass-ceramic compositions. For example, with respect to glasses, the material chosen can be any of a wide range of silicate, borosilicate, aluminosilicate, or boroaluminosilicate glass compositions, which optionally can comprise one or more alkali and/or alkaline earth modifiers.

By way of illustration, one family of compositions includes those having at least one of aluminum oxide or boron oxide and at least one of an alkali metal oxide or an alkali earth metal oxide, wherein −15 mol %≦(R₂O+R′O—Al₂O₃—ZrO₂)—B₂O₃≦4 mol %, where R can be Li, Na, K, Rb, and/or Cs, and R′ can be Mg, Ca, Sr, and/or Ba. One subset of this family of compositions includes from about 62 mol % to about 70 mol % SiO₂; from 0 mol % to about 18 mol % Al₂O₃; from 0 mol % to about 10 mol % B₂O₃; from 0 mol % to about 15 mol % Li₂O; from 0 mol % to about 20 mol % Na₂O; from 0 mol % to about 18 mol % K₂O; from 0 mol % to about 17 mol % MgO; from 0 mol % to about 18 mol % CaO; and from 0 mol % to about 5 mol % ZrO₂. Such glasses are described more fully in U.S. patent application Ser. No. 12/277,573 by Matthew J. Dejneka et al., entitled “Glasses Having Improved Toughness And Scratch Resistance,” filed Nov. 25, 2008, and claiming priority to U.S. Provisional Patent Application No. 61/004,677, filed on Nov. 29, 2008, the contents of which are incorporated herein by reference in their entireties as if fully set forth below.

Another illustrative family of compositions includes those having at least 50 mol % SiO₂ and at least one modifier selected from the group consisting of alkali metal oxides and alkaline earth metal oxides, wherein [(Al₂O₃ (mol %)+B₂O₃ (mol %))/(Σ alkali metal modifiers (mol %))]>1. One subset of this family includes from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O. Such glasses are described in more fully in U.S. patent application Ser. No. 12/858,490 by Kristen L. Barefoot et al., entitled “Crack And Scratch Resistant Glass and Enclosures Made Therefrom,” filed Aug. 18, 2010, and claiming priority to U.S. Provisional Patent Application No. 61/235,767, filed on Aug. 21, 2009, the contents of which are incorporated herein by reference in their entireties as if fully set forth below.

Yet another illustrative family of compositions includes those having SiO₂, Al₂O₃, P₂O₅, and at least one alkali metal oxide (R₂O), wherein 0.75≦[(P₂O₅ (mol %)+R₂O (mol %))/M₂O₃ (mol %)]≦1.2, where M₂O₃═Al₂O₃+B₂O₃. One subset of this family of compositions includes from about 40 mol % to about 70 mol % SiO₂; from 0 mol % to about 28 mol % B₂O₃; from 0 mol % to about 28 mol % Al₂O₃; from about 1 mol % to about 14 mol % P₂O₅; and from about 12 mol % to about 16 mol % R₂O. Another subset of this family of compositions includes from about 40 to about 64 mol % SiO₂; from 0 mol % to about 8 mol % B₂O₃; from about 16 mol % to about 28 mol % Al₂O₃; from about 2 mol % to about 12 mol % P₂O₅; and from about 12 mol % to about 16 mol % R₂O. Such glasses are described more fully in U.S. patent application Ser. No. 13/305,271 by Dana C. Bookbinder et al., entitled “Ion Exchangeable Glass with Deep Compressive Layer and High Damage Threshold,” filed Nov. 28, 2011, and claiming priority to U.S. Provisional Patent Application No. 61/417,941, filed Nov. 30, 2010, the contents of which are incorporated herein by reference in their entireties as if fully set forth below.

Yet another illustrative family of compositions includes those having at least about 4 mol % P₂O₅, wherein (M₂O₃ (mol %)/RₓO (mol %))<1, wherein M₂O₃═Al₂O₃+B₂O₃, and wherein RₓO is the sum of monovalent and divalent cation oxides present in the glass. The monovalent and divalent cation oxides can be selected from the group consisting of Li₂O, Na₂O, K₂O, Rb₂O, Cs₂O, MgO, CaO, SrO, BaO, and ZnO. One subset of this family of compositions includes glasses having 0 mol % B₂O₃. Such glasses are more fully described in U.S. Provisional Patent Application No. 61/560,434 by Timothy M. Gross, entitled “Ion Exchangeable Glass with High Crack Initiation Threshold,” filed Nov. 16, 2011, the contents of which are incorporated herein by reference in their entirety as if fully set forth below.

Still another illustrative family of compositions includes those having Al₂O₃, B₂O₃, alkali metal oxides, and contains boron cations having three-fold coordination. When ion exchanged, these glasses can have a Vickers crack initiation threshold of at least about 30 kilograms force (kgf). One subset of this family of compositions includes at least about 50 mol % SiO₂; at least about 10 mol % R₂O, wherein R₂O comprises Na₂O; Al₂O₃, wherein −0.5 mol %≦Al₂O₃ (mol %)-R₂O (mol %)≦2 mol %; and B₂O₃, and wherein B₂O₃ (mol %)-(R₂O (mol %)-Al₂O₃ (mol %))≧4.5 mol %. Another subset of this family of compositions includes at least about 50 mol % SiO₂, from about 9 mol % to about 22 mol % Al₂O₃; from about 4.5 mol % to about 10 mol % B₂O₃; from about 10 mol % to about 20 mol % Na₂O; from 0 mol % to about 5 mol % K₂O; at least about 0.1 mol % MgO and/or ZnO, wherein 0≦MgO+ZnO≦6 mol %; and, optionally, at least one of CaO, BaO, and SrO, wherein 0 mol %≦CaO+SrO+BaO≦2 mol %. Such glasses are more fully described in U.S. Provisional Patent Application No. 61/653,485 by Matthew J. Dejneka et al., entitled “Ion Exchangeable Glass with High Damage Resistance,” filed May 31, 2012, the contents of which are incorporated herein by reference in their entirety as if fully set forth below.

Similarly, with respect to glass-ceramics, the material chosen can be any of a wide range of materials having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite.

The glass or glass-ceramic substrate can adopt a variety of physical forms. That is, from a cross-sectional perspective, the substrate can be flat or planar, or it can be curved and/or sharply-bent. Similarly, it can be a single unitary object, or a multi-layered structure or laminate. Further, the substrate optionally can be annealed and/or strengthened (e.g., by thermal tempering, chemical ion-exchange, or like processes).

The antimicrobial coating that is disposed, either directly or indirectly, on at least a portion of a surface of the substrate can be formed from a variety of materials, termed “coating precursor materials” herein for convenience only. The coating precursor material and the final antimicrobial coating generally include an amine or protonated amine (ammonium) component to provide the requisite antimicrobial behavior, as well as an inorganic component to provide the ability to strongly bond to the surface of the glass or glass-ceramic substrate. The coating precursor material, and, by extension, the final antimicrobial coating produced therefrom, will also be selected such that it imparts other desirable properties (e.g., appropriate levels of haze, transmittance, durability, and the like) to the final coated article.

Exemplary coating precursor materials that can be used to form the antimicrobial coating include uncured and partially-cured siloxanes having organic side chains (e.g., silsesquioxanes or silicones), wherein at least a portion of the organic side chains include amine or protonated amine substituents. For the purposes of the present disclosure, these coating precursor materials can be designated by the general formula [—R₂SiO-]ₙ, wherein each R in the n repeat groups is independently a hydrogen, hydroxyl, or hydrocarbon group or moiety, with the provisos that not all of the R groups in the n repeat units are hydrogen or hydroxyl, and that at least a portion of the R groups in the n repeat units are hydrocarbon groups having amine or protonated amine substituents. The hydrocarbon group can be a substituted or unsubstituted (e.g., with the amine or protonated amine group), linear or branched, chain or cyclic structure having between 1 and 22 carbons. It is important that these materials are not fully cured prior to their application to the substrate, because a fully cured material will not be able to chemically bond to the glass or glass-ceramic substrate, nor be able to be applied thinly. One illustrative class of such coating precursor materials includes partially-cured primary amine-substituted linear alkyl silsesquioxanes (e.g., partially-cured aminopropyl siloxane, partially-cured aminobutyl siloxane, partially-cured aminopentyl siloxane, and the like).

When such a coating precursor material is used, the antimicrobial coating itself generally will include an at-least-partially-cured siloxane. In most implementations involving an uncured or partially-cured siloxane having organic side chains with amine or protonated amine substituents as the coating precursor material, the final antimicrobial coating will be essentially cured. That is, essentially all of the hydroxyl pendant groups or moieties on the silicon atoms in the coating precursor material will participate in a condensation reaction (i.e., such that they, along with the pendant hydrogen or hydrocarbon “R” groups or moieties of the general structure defined above, are removed from a siloxane unit during the combination of two separate siloxane units). Thus, for the purposes of the present disclosure, “essentially cured” means that a concentration of pendant hydroxyl groups in the partially-cured siloxane of the antimicrobial coating can be less than or equal to about 5 percent of the concentration of any pendant hydrogen and hydrocarbon groups in the partially-cured siloxane of the antimicrobial coating, when measured for example by nuclear magnetic resonance spectroscopy (NMR).

In addition, in most implementations involving an uncured or partially-cured siloxane having organic side chains with amine or protonated amine substituents as the coating precursor material, at least a portion of the organic side chains of the final antimicrobial coating will have protonated amine (ammonium) substituents. That is, the amine substituent can be a primary ammonium, secondary ammonium, or tertiary ammonium group, but will not be a quaternary ammonium group.

In certain embodiments, the coated articles can include a functional layer that can be interposed between the glass or glass-ceramic substrate and the antimicrobial coating, disposed on the antimicrobial coating, and/or disposed on any portions of the glass or glass-ceramic substrate surface that are not covered by the antimicrobial coating. This optional functional layer can be used to provide additional features to the coated article (e.g., fingerprint resistance or anti-fingerprint properties, smudge resistance or anti-smudge properties, reflection resistance or anti-reflection properties, glare resistance or anti-glare properties, color, opacity, environmental barrier protection, electronic functionality, and/or the like). In one implementation, the functional layer might include a coating of SiO₂ nanoparticles bound to at least a portion of the substrate to provide reflection resistance to the final coated article. In another implementation, the functional layer might comprise a multi-layered reflection-resistant coating formed from alternating layers of polycrystalline TiO₂ and SiO₂. In another implementation, the functional layer might comprise a color-providing composition that comprises a dye or pigment material. In another implementation, the functional layer might comprise a fingerprint-resistant coating formed from a hydrophobic and oleophobic material, such as a fluorinated polymer or fluorinated silane. In yet another implementation, the functional layer might comprise a smudge-resistant coating formed from an oleophilic material.

Methods of making the above-described coated articles generally include the steps of providing a glass or glass-ceramic substrate, and forming the antimicrobial coating on at least a portion of a surface of the substrate. In those embodiments where the optional functional layer is implemented, however, the methods generally involve an additional step of forming the functional layer on at least a portion of a surface of the substrate and/or antimicrobial coating. It should be noted that when the functional layer is implemented, the surface fraction of the substrate that is covered by the antimicrobial coating does not have to be the same as the surface fraction covered by the functional layer.

The selection of materials used in the glass or glass-ceramic substrates, antimicrobial coatings, and optional functional layers can be made based on the particular application desired for the final coated article. In general, however, the specific materials will be chosen from those described above for the coated articles.

Provision of the substrate can involve selection of a glass or glass-ceramic object as-manufactured, or it can entail subjecting the as-manufactured glass or glass-ceramic object to a treatment in preparation for forming the optional functional layer or the antimicrobial coating. Examples of such pre-coating treatments include physical or chemical cleaning, physical or chemical strengthening, physical or chemical etching, physical or chemical polishing, annealing, shaping, and/or the like. Such processes are known to those skilled in the art to which this disclosure pertains.

Once the glass or glass-ceramic substrate has been selected and/or prepared, either the optional functional layer or the antimicrobial coating can be disposed thereon. Depending on the materials chosen, these coatings can be formed using a variety of techniques. It is important to note that the coatings described herein (i.e., both the optional functional layer and the antimicrobial coating) are not free-standing films that can be applied (e.g., via an adhesive or other fastening means) to the surface of the substrate, but are, in fact, physically formed on the surface of the substrate.

In general, the optional functional layer and/or the oleophilic coating can be fabricated independently using any of the variants of chemical vapor deposition (CVD) (e.g., plasma-enhanced CVD, aerosol-assisted CVD, metal organic CVD, and the like), any of the variants of physical vapor deposition (PVD) (e.g., ion-assisted PVD, pulsed laser deposition, cathodic arc deposition, sputtering, and the like), spray coating, spin-coating, dip-coating, inkjetting, sol-gel processing, or the like. Such processes are known to those skilled in the art to which this disclosure pertains.

In many implementations, the materials used to form optional functional layer and/or the antimicrobial coating may need to undergo an additional treatment step to finalize these layers. By way of example, in cases when the antimicrobial coating precursor material is applied to the substrate in liquid form, it can undergo a thermal or radiation curing step to form the final antimicrobial coating. In those situations when the antimicrobial coating precursor material is formed from a siloxane material, the curing step is generally a condensation reaction, which results in a structural rearrangement of the individual siloxane units to form a cage- or ladder-like structure.

Once the glass article is formed, it can be used in a variety of applications where the article will come into contact with undesirable microbes. These applications encompass touch-sensitive display screens or cover plates for various electronic devices (e.g., cellular phones, personal data assistants, computers, tablets, global positioning system navigation devices, and the like), non-touch-sensitive components of electronic devices, surfaces of household appliances (e.g., refrigerators, microwave ovens, stovetops, oven, dishwashers, washers, dryers, and the like), medical equipment, biological or medical packaging vessels, architectural components, and vehicle components, just to name a few devices.

Given the breadth of potential uses for the improved antimicrobial glass articles described herein, it should be understood that the specific features or properties of a particular article will depend on the ultimate application therefor or use thereof. The following description, however, will provide some general considerations.

There is no particular limitation on the average thickness of the substrate contemplated herein. In many exemplary applications, however the average thickness will be less than or equal to about 15 millimeters (mm). If the coated article is to be used in applications where it may be desirable to optimize thickness for weight, cost, and strength characteristics (e.g., in electronic devices, or the like), then even thinner substrates (e.g., less than or equal to about 5 mm) can be used. By way of example, if the coated article is intended to function as a cover for a touch screen display, then the substrate can exhibit an average thickness of about 0.02 mm to about 2.0 mm.

In contrast to the glass or glass-ceramic substrate, where thickness is not limited, the average thickness of the antimicrobial coating should be less than or equal to about 10 micrometers (μm). If the antimicrobial coating is much thicker than this, it could have adverse effects on the haze, optical transmittance, scratch resistance, and/or durability of the final coated article. To illustrate, with thinner antimicrobial coatings, a potential scratch to the surface can be resisted better by the more durable underlying substrate, because the scratch is actually absorbed by the underlying substrate rather than the coating. If the antimicrobial coating is thicker than 100 nanometers (nm) on average, then the scratch will be absorbed by the coating itself and will be visible to the naked eye. Thus, in applications where high scratch resistance is important or critical (in addition to the improved antimicrobial efficacy provided by the antimicrobial coating), the average thickness of the antimicrobial coating should be less than or equal to 75 nm.

The thickness of the optional functional layer will be dictated by its function. For glare and/or reflection resistance for example, the average thickness should be less than or equal to about 200 nm. Coatings that have an average thickness greater than this could scatter light in such a manner that defeats the glare and/or reflection resistance properties. For fingerprint and/or smudge resistance, the average thickness should be less than or equal to about 100 nm.

In general, the optical transmittance of the coated article will depend on the type of materials chosen. For example, if a glass or glass-ceramic substrate is used without any pigments added thereto and/or the antimicrobial coating is sufficiently thin, the coated article can have a transparency over the entire visible spectrum of at least about 85%. In certain cases where the coated article is used in the construction of a touch screen for an electronic device, for example, the transparency of the coated article can be at least about 92% over the visible spectrum. In situations where the substrate comprises a pigment (or is not colorless by virtue of its material constituents) and/or the antimicrobial coating is sufficiently thick, the transparency can diminish, even to the point of being opaque across the visible spectrum. Thus, there is no particular limitation on the optical transmittance of the coated article itself.

Like transmittance, the haze of the coated article can be tailored to the particular application. As used herein, the terms “haze” and “transmission haze” refer to the percentage of transmitted light scattered outside an angular cone of ±4.0° in accordance with ASTM procedure D1003, the contents of which are incorporated herein by reference in their entirety as if fully set forth below. For an optically smooth surface, transmission haze is generally close to zero. In those situations when the coated article is used in the construction of a touch screen for an electronic device, the haze of the coated article can be less than or equal to about 5%.

In implementations where the glass or glass-ceramic substrate is strengthened, the substrate will have a layer under compression that extends from a surface of the substrate itself inward to a selected depth. While each surface of the coated article's substrate can have a layer under compression, for the purposes of the present disclosure, when a substrate is described as having such a layer, the surface of reference is at least that on which the antimicrobial coating is disposed. The compressive stress (CS) of the layer under compression, and the depth of this layer (DOL) can be measured using a glass or glass-ceramic surface stress meter, which is an optical tool that generally uses the photoelastic constant and index of refraction of the substrate material itself, and converts the measured optical interference fringe patterns to specific CS and DOL values. In those situations when the coated article is used in the construction of a touch screen for an electronic device, the CS and DOL of the coated article generally can be, respectively, about 400 megaPascals (MPa) to about 1200 MPa and about 30 μm to about 80 μm. Importantly, in many implementations, the CS and DOL each do not change by more than about 5 percent after the antimicrobial coating (including any optional functional layer(s)) is disposed thereon.

Regardless of the application or use, the coated articles described herein offer improved antimicrobial efficacy relative to identical articles that lack the antimicrobial coatings described herein.

The antimicrobial activity and efficacy of the antimicrobial glass articles described herein can be quite high. The antimicrobial activity and efficacy can be measured in accordance with Japanese Industrial Standard JIS Z 2801 (2000), entitled “Antimicrobial Products—Test for Antimicrobial Activity and Efficacy,” the contents of which are incorporated herein by reference in their entirety as if fully set forth below. Under the “wet” conditions of this test (i.e., about 37° C. and greater than 90% humidity for about 24 hours), the antimicrobial glass articles described herein can exhibit at least a 5 log reduction in the concentration (or a kill rate of 99.999%) of at least Staphylococcus aureus, Enterobacter aerogenes, and Pseudomomas aeruginosa bacteria. In certain implementations, the antimicrobial glass articles described herein can exhibit at least a 7 log reduction in the concentration of any bacteria to which it is exposed under these testing conditions.

In scenarios where the wet testing conditions of JIS Z 2801 do not reflect actual use conditions of the antimicrobial glass articles described herein (e.g., when the glass articles are used in electronic devices, or the like), the antimicrobial activity and efficacy can be measured using “drier” conditions. For example, the glass articles can be tested using a modified version of the protocol adopted by the United States Environmental Protection Agency for use on copper-containing surfaces, entitled “Test Method for Efficacy of Copper Alloy Surfaces as a Sanitizer.” The modification can entail substitution of the copper-containing surfaces for the coated articles described herein with an uncoated glass or glass-ceramic substrate used as the standard or control sample. Using this test, the coated articles described herein can exhibit at least a 2 log reduction in the concentration (or a kill rate of 99%) of at least Staphylococcus aureus, Enterobacter aerogenes, and Pseudomomas aeruginosa bacteria. In certain implementations, the coated articles described herein can exhibit at least a 3 log reduction in the concentration of any bacteria to which it is exposed under these testing conditions.

In a specific embodiment that might be particularly advantageous for applications such as touch accesses or operated electronic devices, an antimicrobial coated article is formed from a chemically strengthened (ion exchanged) alkali aluminosilicate flat glass sheet. The CS and DOL of the coated article can be, respectively, about 600 MPa to about 1000 MPa and about 40 μm to about 70 μm. The antimicrobial coating is formed from a partially-cured aminopropyl silsesquioxane (APSSQ) coating precursor, and is directly coated on one surface of the glass sheet. The average thickness of the glass sheet is less than or equal to about 1 mm, and the average thickness of the APSSQ antimicrobial coating is less than or equal to about 2 μm. The formed APSSQ antimicrobial coating can have a concentration of pendant hydroxyl groups that is less than or equal to about 3 percent of the concentration of any pendant aminopropyl groups therein. After formation of the coating, the CS and DOL of the coated article change less than about 3% and about 1%, respectively.

Such a coated article can be used in the fabrication of a touch screen display for an electronic device. The coated article can have an optical transmittance of at least about 94% and a haze of less than 0.1%. In addition, such an antimicrobial glass article can exhibit at least a 5 log reduction in the concentration any bacteria to which it is exposed under the testing conditions of JIS Z 2801 and at least a 2 log reduction in the concentration any bacteria to which it is exposed under the testing conditions of the United States Environmental Protection Agency's (EPA) test entitled “Test Method for Efficacy of Copper Alloy Surfaces as a Sanitizer” as modified for glass use.

### Examples

Various samples were tested for antimicrobial efficacy using the following test methods. Some samples were subjected to the “Test Method for Efficacy of Copper Alloy Surfaces as a Sanitizer” using the EPA approved dry test procedure. The test procedure included cutting each sample glass into a glass slide having dimensions of 1 inch×1 inch and placing the glass slides into a petri dish in triplicate. Uncoated glass slides were used as negative controls. Gram positive Staphylococcus aureus bacterial were cultured for at least 3 consecutive days before testing, on the day of testing, and the inocula was cultured for at least 48 hours. The procedure also included vortexing the bacterial culture, and adding serum (at 5% final concentration) and Triton X-100 (final concentration 0.01%) to the inocula. Each sample was inoculated with 20 μl aliquot of the bacterial suspension. The samples were allowed to dry for about 30-40 minutes at room temperature at 42% relative humidity. After the samples were dried, the samples were allowed a two hour exposure time. Thereafter, the bacteria were counted by adding 4 ml of PBS buffer into each petri dish. The petri dish was shaken and all the solution from the petri dish was collected and placed onto a Trypticase soy agar plate. The collected solution was incubated in an incubator for an additional 24 hours at 37° C. The bacteria colony formation was then examined. Geometric mean was used to calculate the log and percent reduction based on the colony number on the sample glass and control glass.

Various samples were also subjected to an “Antimicrobial Burden Test”, which is based on Test Method for Efficacy of Copper Alloy Surfaces as a Sanitizer” using the EPA approved dry test procedure. In this test, sample glass to be tested was cut and placed into a petri dish in the same manner as the EPA approved dry test procedure. Bare glass slides were used as negative controls. Gram positive Staphylococcus Aureus bacterial were cultured for at least 3 consecutive days before testing, on the day of testing, and the inocula was cultured for at least 48 hours. The procedure included vortexing the bacterial culture, and adding serum (at 5% final concentration) and Triton X-100 (final concentration 0.01%) to the inocula. The procedure also including inoculating each sample with 20 μl aliquot of the bacterial suspension, and allowing samples to dry for about 30-40 minutes at room temperature at 42% relative humidity. After the samples are dried, the samples were allowed a two hour exposure time. After the two hour exposure time, the same surface was inoculated again in the same manner and the sample was allowed to dry for about 30-40 minutes. The samples were then allowed a two hour exposure time. The bacteria were counted by adding 4 ml of PBS buffer into each petri dish. The petri dish was shaken and all the solution from the petri dish was collected and placed onto a Trypticase soy agar plate. The collected solution was incubated in an incubator for an additional 24 hours at 37° C. The bacteria colony formation was examined. Thereafter, the surface was inoculated again in the same manner and allowed to dry and allowed a two hour exposure time an additional 7 times (for a total of 9 inoculations). Thereafter, the bacteria were counted by adding 4 ml of PBS buffer into each petri dish. The petri dish was shaken and all the solution from the petri dish was collected and placed onto a Trypticase soy agar plate. The collected solution was incubated in an incubator for an additional 24 hours at 37° C. The bacteria colony formation was examined. In each bacteria colony formation examination, geometric mean was used to calculate the log and percent reduction based on the colony number on sample glass and control glass.

Various samples were subjected to the JIS Z 2801 test protocol. In this test, the sample glass to be tested was cut and placed into a petri dish in the same manner as the EPA approved dry test procedure. Three uncoated glass slides were used as negative controls. Gram negative E. coli bacteria were suspended in a 1/500 LB medium at a concentration of 1×10⁶ cell/ml. 156 μl of E. coli suspension was placed onto each sample surface and held in close contact by using a sterilized laboratory PARAFILM, and incubated for 6 hours at 37° C. at saturation humidity (>95% relative humidity). Each sample was tested in triplicate. After 6 hours incubation, the bacteria were counted by adding 2 ml of PBS buffer into each petri dish. The petri dish was shaken and then both the slide and PARAFILM were washed, and all the solution from each petri dish was collected and placed onto a LB agar plate. The collected solution was incubated in an incubator for an additional 16 hours at 37° C. The bacteria colony formation was examined.

Samples were prepared by providing an antimicrobial coating formed from a partially-cured APSSQ coating precursor on glass substrates. Prior to application, the pH of the antimicrobial coating evaluated. Due to the nature of the silsesquioxane backbone, the amine group appears to be protonated in solution (pH>10) and can remain protonated after the coating and curing conditions. When pH was monitored on surfaces covered with 10 μl H₂O drop or using PBS solution, the pH consistently remained >8 and for higher solution concentration based coatings the pH>9 (Table 1).

TABLE 1
Measured pH values of various antimicrobial coatings,
after the coating has equilibrated with water.

| | | wet test condiiton |
|---|---|---|
| | pH (2 hour) | pH (6 hour) |
| APSSQ | DI H20 | PBS |
| 25% | 11-12 | |
| 1% | 9-10 | 8-9 |
| 0.10% | ~9 | |
| 0.01% | 8-9 | |

An antimicrobial coating with a 1% concentration was applied to glass substrates. The coated samples were then subjected to the Test Method for Efficacy of Copper Alloy Surfaces as a Sanitizer, described above. The results of the test are provided in Table 2, which show that the antimicrobial coating with 1% solution concentration exhibited a log kill >99%. Table 3 shows the concentration dependence and the log kill. As the concentration of protonated primary amine groups in the antimicrobial coating increased, the log kill also increased, suggesting the dependence of the amino group or the hydrogen bonded primary ammonium group in killing the bacteria.

TABLE 2
Results from Test Method for Efficacy of Copper Alloy Surfaces as a
Sanitizer, using 1% concentration of APSSQ precursor.

| | |
|---|---|
| Bacteria tested: S. aureus | Conditions: |

| | |
|---|---|
| Concentration of | 23° C., 40-42% RH |

| APSSQ precursor | % Kill | Log Kill | Stdev |
|---|---|---|---|
| 1% | 99.80 | 2.87 | |
| 1% | 99.87 | 2.87 | 1.41 |
| 1% | 99.96 | 3.35 | |

TABLE 3
Results from Test Method for Efficacy of Copper Alloy Surfaces as a
Sanitizer, using different concentrations of APSSQ precursor.

| | |
|---|---|
| Bacteria tested: | |
| S. aureus | Conditions: |
| Concentration of | 23° C., 42% RH |

| APSSQ precursor | % Kill | Log Kill |
|---|---|---|
| 1% | 99.82 | 2.76 |
| 0.5% | 98.25 | 1.76 |
| 0.05% | 96.44 | 1.45 |

Samples having an antimicrobial coating of 1% concentration of APSSQ precursor were prepared and tested under the Test Method for Efficacy of Copper Alloy Surfaces as a Sanitizer, after using various hospital cleaners (e.g., 70% ethanol solutions and 10% bleach solutions) on the samples. The cleaning procedure included removing dust and dirt from the glass surface, holding a spray bottle containing the cleaning solution about 6-8 inches away from the surface, spraying the cleaning solution totally over the surface, waiting 3 minutes and wiping to dry. The cleaning procedure was repeated 10 times. Thereafter, the samples were washed with PBS and water before testing as described above. Table 4 shows the results after the cleaning procedure was performed. As shown in Table 4, the samples exhibited antimicrobial activity, even after a cleaner was applied.

TABLE 4
Results from Test Method for Efficacy of Copper Alloy Surfaces as a
Sanitizer, using 1% concentration of APSSQ precursor, after cleaning
with 70% ethanol and 10% bleach solutions.

| Bacteria tested: S. aureus | | Conditions: |
|---|---|---|
| Concentration of | Cleaning | 23° C., 42% RH |

| APSSQ precursor | solution | Log Kill | % Kill |
|---|---|---|---|
| 1% | 70% ethanol | 2.032118 | 99.07129 |
| 1% | 10% bleach | 1.532133 | 97.06325 |

Samples including an antimicrobial coating with a 1% concentration APSSQ precursor were tested using the Antimicrobial Burden Test. Controls of silver-ion containing glass and copper-containing glass were used. The antimicrobial coatings were both prepared using water and ethanol. Results for these coatings were measured after 2 inoculations and then again after 7 inoculations. The surfaces even after 7 inoculations showed good log kill compared to the controls.

TABLE 5
Results from Antimicrobial Burden Test, using 1% concentration
of APSSQ precursor.

| | | | Antibacterial Test | | |
|---|---|---|---|---|---|
| Mar. 8, 2012 S. aureus | | | 23 C./42% RH | | Bio |
| | Solution | | | Log | Loading |
| | conc | Rinse solvent | Innoculations | Kill | % Kill |
| APSSQ | 1% | rinse in ethanol | 2 | 2.1 | 99.2 |
| APSSQ | 1% | rinse in water | 2 | 1.9 | 98.7 |
| Ag in glass | | | 2 | 0.1 | 28.5 |
| Cu in glass | | | 2 | 2.2 | 99.4 |
| APSSQ | 1% | rinse in ethanol | 7 | 1.4 | 95.7 |
| APSSQ | 1% | rinse in water | 7 | 1.2 | 93.3 |
| Ag in glass | | | 7 | 0.1 | 25.5 |
| Cu in glass | | | 7 | 0.6 | 73.5 |

Samples including an antimicrobial coating with 1% concentration of APSSQ precursor were tested under the JIS Z2801 test. Table 6 shows the results from these samples. The results are compared to those from commercially available aminopropylsilane coated glass (Corning GAPS® slides). The samples with the antimicrobial coating with 1% concentration of APSSQ precursor coating showed >log 5 kill.

While the embodiments disclosed herein have been set forth for the purpose of illustration, the foregoing description should not be deemed to be a limitation on the scope of the disclosure or the appended claims. Accordingly, various modifications, adaptations, and alternatives may occur to one skilled in the art without departing from the spirit and scope of the present disclosure or the appended claims.

What is claimed is:

1. A coated article, comprising:
a glass or glass-ceramic substrate; and
an antimicrobial coating disposed on at least a portion of a surface of the glass or glass-ceramic substrate;
wherein the antimicrobial coating comprises an at least partially cured siloxane comprising organic side chains, wherein at least a portion of the organic side chains comprise protonated amine substituents or amine substituents comprising at least one hydrogen.

2. The coated article of claim 1, wherein the functional layer comprises a fingerprint-resistant coating, smudge-resistant coating, reflection-resistant coating, a glare-resistant coating, a color-providing composition, an environmental barrier coating, or an electrically conductive coating.

3. The coated article of claim 2, further comprising a functional layer interposed between the glass or glass-ceramic substrate and the antimicrobial coating.

4. The coated article of claim 2, further comprising a functional layer disposed on at least a portion of the antimicrobial coating.

5. The coated article of claim 2, further comprising a functional layer disposed on the surface of the glass or glass-ceramic substrate in a region on which the antimicrobial coating is not disposed.

6. The coated article of claim 1, wherein the glass or glass-ceramic substrate comprises a silicate glass, borosilicate glass, aluminosilicate glass, or boroaluminosilicate glass, which optionally comprises an alkali or alkaline earth modifier.

7. The coated article of claim 1, wherein the glass or glass-ceramic substrate is a glass-ceramic comprising a glassy phase and a ceramic phase, wherein the ceramic phase comprises β-spodumene, β-quartz, nepheline, kalsilite, or carnegieite.

8. The coated article of claim 1, wherein the glass or glass-ceramic substrate has an average thickness of less than or equal to about 2 millimeters.

9. The coated article of claim 1, wherein the antimicrobial coating is formed from a uncured or partially-cured siloxane coating precursor material comprising organic side chains wherein at least a portion of the organic side chains comprise protonated amine substituents or amine substituents comprising at least one hydrogen.

10. The coated article of claim 9, wherein the uncured or partially-cured siloxane coating precursor material is a partially-cured primary amine-substituted linear alkyl silsesquioxane coating precursor material.

11. The coated article of claim 10, wherein the partially-cured primary amine-substituted linear alkyl silsesquioxane coating precursor material is a partially-cured aminopropyl silsesquioxane coating precursor material.

12. The coated article of claim 1, wherein the coated article exhibits at least a 5 log reduction in a concentration of at least Staphylococcus aureus, Enterobacter aerogenes, and Pseudomomas aeruginosa bacteria under JIS Z 2801 (2000) testing conditions.

13. The coated article of claim 1, wherein the coated article exhibits at least a 2 log reduction in a concentration of at least Staphylococcus aureus, Enterobacter aerogenes, and Pseudomomas aeruginosa bacteria under modified United States Environmental Protection Agency “Test Method for Efficacy of Copper Alloy Surfaces as a Sanitizer” testing conditions, wherein the modified conditions comprise substitution of a copper-containing surface for the coated article, and substitution of the glass or glass-ceramic substrate without the antimicrobial coating disposed thereon as a control sample.

14. The coated article of claim 1, wherein the glass or glass-ceramic substrate is a chemically strengthened glass or glass-ceramic substrate comprising a layer under compression that extends from the surface of the glass or glass-ceramic substrate inward to a selected depth.

15. The coated article of claim 14, wherein the layer under compression comprises a compressive stress in the range from about 400 megaPascals to about 1200 megaPascals, and the depth of the layer under compression is about 30 micrometers to about 80 micrometers.

16. The coated article of claim 1, wherein the antimicrobial glass article comprises a portion of a touch-sensitive display screen or cover plate for an electronic device, a non-touch-sensitive component of an electronic device, a surface of a household appliance, a surface of medical equipment, a biological or medical packaging vessel, an architectural component, or a surface of a vehicle component.

17. A method of making a coated article, the method comprising:
forming an antimicrobial coating from an antimicrobial coating precursor material on at least a portion of a surface of a glass or glass-ceramic substrate;
wherein the antimicrobial coating comprises an at least partially cured siloxane comprising organic side chains, wherein at least a portion of the organic side chains comprise protonated amine substituents or amine substituents comprising at least one hydrogen; and
wherein the antimicrobial coating precursor material comprises an uncured or partially-cured siloxane coating precursor material comprising organic side chains wherein at least a portion of the organic side chains comprise protonated amine substituents or amine substituents comprising at least one hydrogen.

18. The method of claim 17, further comprising forming a functional layer on at least a portion of the surface of the glass or glass-ceramic substrate prior to forming the antimicrobial coating, wherein the functional layer comprises a fingerprint-resistant coating, smudge-resistant coating, reflection-resistant coating, a glare-resistant coating, a color-providing composition, an environmental barrier coating, or an electrically conductive coating.

19. The method of claim 17, further comprising forming a functional layer on at least a portion of the antimicrobial coating, wherein the functional layer comprises a fingerprint-resistant coating, smudge-resistant coating, reflection-resistant coating, a glare-resistant coating, a color-providing composition, an environmental barrier coating, or an electrically conductive coating.

20. The method of claim 17, further comprising forming a functional layer on a region on the surface of the glass or glass-ceramic substrate on which the antimicrobial coating is not disposed, wherein the functional layer comprises a fingerprint-resistant coating, smudge-resistant coating, reflection-resistant coating, a glare-resistant coating, a color-providing composition, an environmental barrier coating, or an electrically conductive coating.
